(19) United States
(12) Patent Application Publication
(10) Pub. No.: US 2022/0212359 A1
(43) Pub. Date: Jul. 7, 2022

(54) Safety razor

(71) Applicant: Christoph LEMKE, Kelkheim (DE)

(72) Inventor: Christoph LEMKE, Kelkheim (DE)

(21) Appl. No.: 17/609,035

(22) PCT Filed: Mar. 2, 2020
(86) PCT No.: PCT/DE2020/000042

§ 371 Date: Nov. 5, 2021

(30) Foreign Application Priority Data
May 6, 2019 (DE) 10 2019 003 160.1
May 6, 2019 (DE) 20 2019 001 953.7

(51) Int. Cl. B26B 21/10

(52) U.S. Cl. CPC B26B 21/10

(57) ABSTRACT

A razor comprises cutting elements, e.g. razor blades, and fixing elements that make the razor safer to handle and more functionally reliable for use. The razor is suitable for technologically advantageous mass production. The razor requires less technological complexity to produce and reduces the risk of injury when handling. The razor includes fixing elements that have been introduced into the material of a first foldable shaft of the razor arranged at least on the surface of the shaft, between which fixing elements the position of the cutting element is reversibly fixed and a two-dimensional shift in position of the cutting element is counteracted by the arrangement of the fixing elements, and receiving points that receive the fixing elements and are formed in a form-fitting manner having been introduced into the opposite foldable second shaft of the razor on the surface facing the cutting element.

### TECHNICAL FIELD

The disclosure relates to a razor comprising cutting elements (e.g. razor blades), which comprises fixing elements that make the razor safer to handle and more functionally reliable for use. As a result of its efficient structure in terms of materials, the razor produced is suitable for technologically advantageous mass production.

### BACKGROUND

Swiss patent application 10.048/63 discloses a folding razor comprising a bar-shaped razor body and an elongate handle part, which is arranged so as to pivot on the rear part thereof and consists of two longitudinal halves, between which the cutting edge of the razor body is arranged when the razor is folded up. The razor body is provided with a support surface, which serves to receive a razor blade. Two pins arranged at a distance from the blade-fastening openings are provided on this surface, by means of which pins the razor blade is brought into its shaving position. The razor blade is secured in this position by means of a retaining member that can be fitted to the razor body. To do this, the fastening openings of the razor blade are slipped over the pins of the razor body. The cover plate is then placed onto the blade such that the pins project into circular extensions of longitudinal grooves and, by being moved in the longitudinal direction, are aligned with the front part of the razor body. A drawback of this razor is the high technical and material-related production complexity owing to the large number of individual parts.

Furthermore, DE 25 15 183 discloses a razor comprising a replaceable blade, wherein the blade carrier is longitudinally displaceably arranged in a guide body that is designed as a sheath of the razor and holds the blade in a resilient manner. The blade carrier is moved relative to the sheath along its longitudinal axis and as a result in a direction extending approximately transversely to the shaving direction. This measure avoids the risk of the blade carrier slipping out and the blade coming off during shaving. Drawbacks of this razor are also the complicated construction and the relatively long amount of time needed and the material-related complexity when producing the razor.

In the razor and hair-cutting device described in DE 102 37 218 B4 comprising a blade holder that can be inserted in a replaceable manner, the blade holder is inserted in a receiving pocket made in an end of a handle body. For fixing the blade holder in the receiving pocket, a locking element is used, which can be unlocked or locked manually by means of an actuating button. The cutting blade is exchanged by exchanging the complete blade holder. These technical measures achieve greater handling safety when dealing with the cutting blades. This is, however, associated with high material complexity for the blade holder and high technological complexity for the production of the shaving device.

Furthermore, according to US 2013/0333221 A1, a shaving apparatus is set out which allows the user to move the blade between two different positions. In the first position, the two sharp edges of the blade that project outwards are covered, in order to ensure that the shaving apparatus can be handled with no problems when shaving. The second possible position of the razor acts as a tool for correcting the contour shape of the haircut. For this purpose, the razor consists of an upper and a lower shaft, which are pivotally fastened to a handle. The shafts are connected to the handle by means of a screw and enclose the blade holder. In order to hold the blade, two pins are arranged on the surface of one of the two shafts and holes are made in the facing surface of the other shaft, into which holes the pins are inserted in a form-fitting manner after positioning the blade and after the closing process by pivoting the shaft. In this shaving apparatus, no provision is made for preventing a possible two-dimensional shift in position and the associated risk of injury. In addition, the technological expenditure required for production is relatively high due to the complexity of the construction of the shaving apparatus.

### SUMMARY

An object of the disclosure is to provide a razor which requires less technological complexity to produce and in which the risk of injury when handling the razor is reduced.

This object is achieved by the razor as claimed.

The increased safety against injury when handling the razor is achieved by fixing elements that have been introduced into the material of a first foldable shaft of the razor being arranged at least on the surface of the shaft, between which fixing elements the position of the cutting element is reversibly fixed. By means of the arrangement of the fixing elements provided, a possible two-dimensional shift in position of the cutting element is counteracted. By means of the arrangement of the receiving points that receive the fixing elements and are formed in a form-fitting manner in the opposite foldable second shaft of the razor, a simple solution that is technologically advantageous to produce is provided for the closure of the razor. Advantageously, the fixing elements are arranged by fixing elements being mechanically embossed into the material of the shaft on one of the inner surfaces of the foldable shafts of the razor facing the cutting element and counteracting a shift in position of the cutting element in any possible movement direction by means of their arrangement. When using razor blades as the cutting element, the arrangement of the fixing elements is efficiently selected such that the fixing elements can be inserted into the contours made on the edges of the cutting element that are not used as a cutting edge in a form-fitting manner. For the use of cutting elements comprising cut-outs, the fixing elements are advantageously arranged such that they can be inserted into cut-outs in the cutting element in a form-fitting manner when fixing the cutting element in position and counteract a two-dimensional shift in position of the cutting element. The form-fitting receiving points that receive the fixing elements are effectively made in the material of the shaft in the form of indentations and/or perforations. When using poorly deformable materials for the shafts, it is advantageous, during the mechanical production, for the fixing elements to be designed as deformations made in the material of the shaft by means of blanking punches. An optimized arrangement of the fixing elements is effectively achieved for cutting elements comprising cut-outs by said fixing elements being inserted into cut-outs and into the contours made on the edges of the cutting element that are not used as a cutting edge in a form-fitting manner when fixing the cutting element in position and counteracting a two-dimensional shift in position of the cutting element in their entirety. A more precise construction of the razor and efficient production of the razor are achieved by the shaft comprising the fixing elements and/or the shaft comprising the receiving points each being in the form of a one-piece assembly produced by means of casting methods.

By mechanically introducing the fixing elements and receiving elements into the base material of the shafts, which takes place during the production process, the technological production complexity is significantly reduced. No additional materials to be introduced are required for the fixing, and this again achieves a construction of the razor that is efficient in terms of materials. In addition to achieving production that is more efficient in terms of technology, time and materials, the construction of the razor is simplified and the risk of injury when handling the razor is likewise reduced.

In the following, the invention will be explained in greater detail on the basis of an exemplary embodiment.

### BRIEF DESCRIPTION OF THE DRAWINGS

FIG. 1 shows the first shaft with the arrangement of the fixing elements and

FIG. 2 shows the second shaft with the arrangement of the receiving points for the fixing elements.

### DETAILED DESCRIPTION

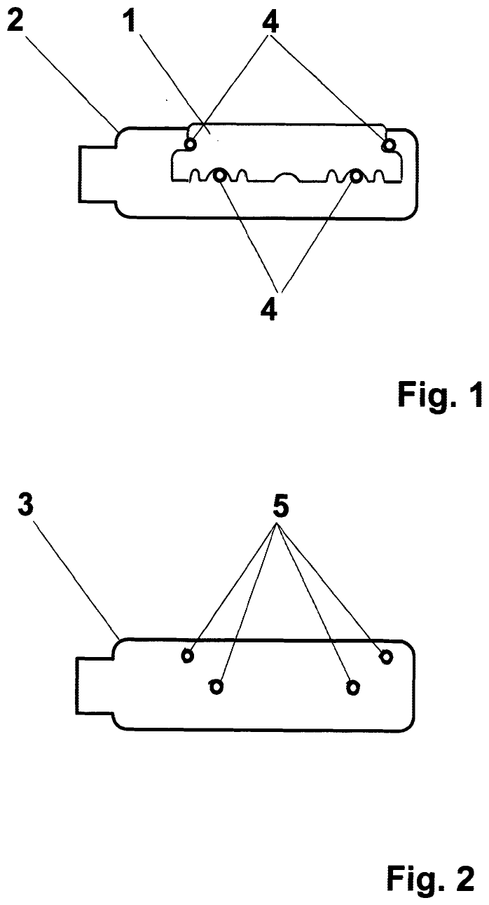

The schematic view in FIG. 1 shows the upper part of the pivotable shaft 2 having a possible arrangement of the fixing elements 4. The cutting element 1 is reversibly fixed in its position to the surface of the shown shaft region by the fixing elements 4 so as to be in the form of a divided razor blade. To do this, the fixing elements 4 are positioned on the edges of the cutting element 1 such that a two-dimensional shift in position is prevented. The fixing elements 4 that are raised over the surface of the shaft region have been made in the material by mechanical embossing processes or by cutting/punching processes when producing the shaft body. Likewise, it is possible to introduce the fixing elements 4 by producing the shaft 2 in an integrated manner by means of casting methods. Additional materials, for example for pins or studs, become superfluous as a result. In the process, the points for introducing the fixing elements 4 into the shaft material can be selected such that they abut the contour edge of the cutting element 1 during positioning and/or project in the surface of the cutting element 1 through cut-outs.

FIG. 2 is a schematic view of the upper region of the second shaft 3 with the arrangement of the receiving elements for the fixing elements 4. The receiving elements are formed such that they are used for receiving the relevant upper region of the fixing elements 4 in a form-fitting manner. Once the first shaft 2 has pivotally moved towards the second shaft 3, a position results in which the upper shaft regions lie one on top of the other. In this position, the upper regions of the fixing elements 4 are below the receiving spaces of the receiving elements and are fitted into the receiving spaces by a spring effect provided between the two shafts 2, 3. The receiving elements may be formed as indentations or hole-shaped perforations 5 made mechanically during production of the shaft 3, for example. The receiving elements may also be introduced by producing the shaft 3 in an integrated manner by means of casting methods.

### REFERENCE SIGNS

1 Cutting element

2 Foldable shaft

3 Foldable shaft

4 Fixing element

5 Perforation

1.-8. (canceled)

9. A safety razor, comprising:
a first foldable shaft (2);
a second foldable shaft (3);
a cutting element (1) arranged between the first foldable shaft (2) and the second foldable shaft (3);
fixing elements (4) that have been introduced into a material of the first foldable shaft (2) and that are arranged at least on a surface of the first foldable shaft (2), between which fixing elements a position of the cutting element (1) is reversibly fixed and a two-dimensional shift in position of the cutting element (1) is counteracted by the arrangement of the fixing elements (4); and
receiving points that receive the fixing elements (4) and are formed in a form-fitting manner and that have been introduced into the second foldable shaft (3) on a surface facing the cutting element (1).

10. The safety razor according to claim 9,
wherein the fixing elements (4) are embossed into the material of the first foldable shaft (2) are arranged on an inner surfaces of the first foldable shaft (2) facing the cutting element (1) such that the fixing elements (4) counteract a shift in position of the cutting element (1) in any movement direction.

11. The safety razor according to claim 9,
wherein the fixing elements (4) are formed such that they can be inserted into contours on edges of the cutting element (1) that are not used as a cutting edge in a form-fitting manner.

12. The safety razor according to claim 9,
wherein the fixing elements (4) are arranged such that they can be inserted into cut-outs in the cutting element (1) in a form-fitting manner when fixing the cutting element (1) in position and counteract the two-dimensional shift in position of the cutting element (1).

13. The safety razor according to claim 9,
wherein the receiving points are made in a material of the second foldable shaft (3) in form of indentations and/or perforations (5).

14. The safety razor according to claim 9,
wherein the fixing elements (4) are designed as deformations made in the material of the shaft (2) by means of blanking punches.

15. The safety razor according to claim 9,
wherein the first foldable shaft (2) comprising the fixing elements (4) and/or the second foldable shaft (3) comprising the receiving points are each in the form of a one-piece assembly produced by casting.

16. The safety razor according to claim 9,
wherein the fixing elements (4) are arranged such that they can be inserted into cut-outs in the cutting element (1) and into contours made on edges of the cutting element (1) that are not used as a cutting edge in a form-fitting manner when fixing the cutting element (1) in position and counteract the two-dimensional shift in position of the cutting element (1) in their entirety.
